(19) United States
(12) Patent Application Publication
(10) Pub. No.: US 2019/0240698 A1
(43) Pub. Date: Aug. 8, 2019

(54) HAPTIC DEVICE

(71) Applicant: TOYODA GOSEI CO., LTD., Kiyosu-shi (JP)

(72) Inventors: Yuji YONEHARA, Kiyosu-shi (JP); Takeshi FUJIWARA, Kiyosu-shi (JP)

(21) Appl. No.: 16/261,890

(22) Filed: Jan. 30, 2019

(30) Foreign Application Priority Data
Feb. 7, 2018 (JP) 2018-020074

(51) Int. Cl. B06B 3/00; B06B 1/02; B06B 1/06; G08B 6/00

(52) U.S. Cl. CPC B06B 3/00; G08B 6/00; B06B 1/0644; B06B 1/0207

(57) ABSTRACT

A haptic device includes a flexible covering, an actuator provided in the covering and configured to generate vibration, and transmission particles filling the covering.

### BACKGROUND

The following description relates to a haptic device that transmits vibration generated by an actuator to tactile receptors of a user.

One example of such haptic devices is a mobile phone incorporating a vibrator (for example, refer to Japanese Laid-Open Patent Publication No. 2009-15952).

A haptic device such as a mobile phone transmits vibration of an actuator to tactile receptors of a user via a rigid casing made of a hard plastic, for example. However, when the covering, such as the casing, is made of a flexible rubber or the like, vibration of the actuator is not readily transmitted to the cover.

### SUMMARY

Accordingly, it is an objective of the present disclosure to provide a haptic device capable of transmitting vibration to a flexible cover in a favorable manner.

In accordance with one aspect of the present disclosure, a haptic device is provided that includes a flexible covering, an actuator provided in the covering and configured to generate vibration, and transmission particles filling the covering.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a plan view of the main body of a haptic device according to an embodiment.

FIG. 2 is a cross-sectional view of the device main body of the embodiment shown in FIG. 1.

FIG. 3 is a cross-sectional side view illustrating a layer structure of an actuator of the embodiment shown in FIG. 1.

FIG. 4 is a plan view illustrating an example of a manner in which the haptic device of the embodiment shown in FIG. 1 is used.

### DETAILED DESCRIPTION

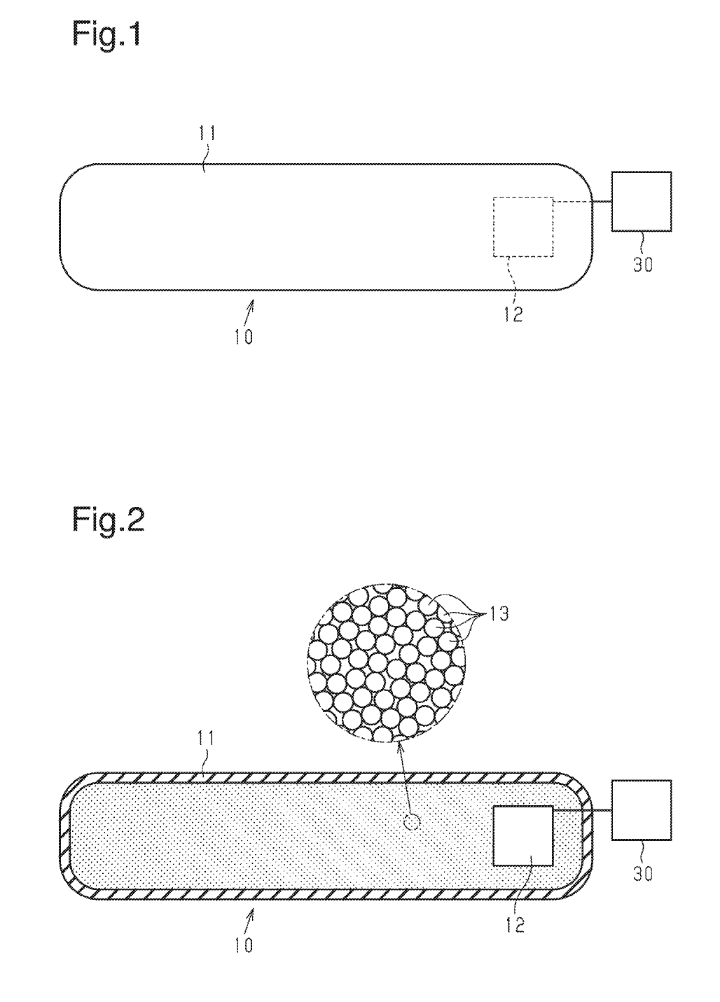

A haptic device according to an embodiment will now be described with reference to FIGS. 1 to 4.

As shown in FIGS. 1 and 2, the haptic device includes a main body 10 and a controller 30. The main body 10 includes a flexible tubular covering 11 having closed ends, an actuator 12 provided inside the covering 11 and generating vibration, and a great number of transmission particles 13 filling the covering 11. The controller 30 controls the mode of vibration of the actuator 12.

The covering 11 may be made of, for example, a flexible silicone rubber. The thickness of the covering 11 is, for example, 0.1 mm to 3 mm. The thickness of the covering 11 is, for example, approximately 2 mm.

The transmission particles 13 are spherical and may be made of foamed plastic such as foamed polystyrene. The diameter of the transmission particles 13 may be 0.1 mm to 3 mm. According to embodiments, the average diameter of the transmission particles 13 is, for example, approximately 0.7 mm.

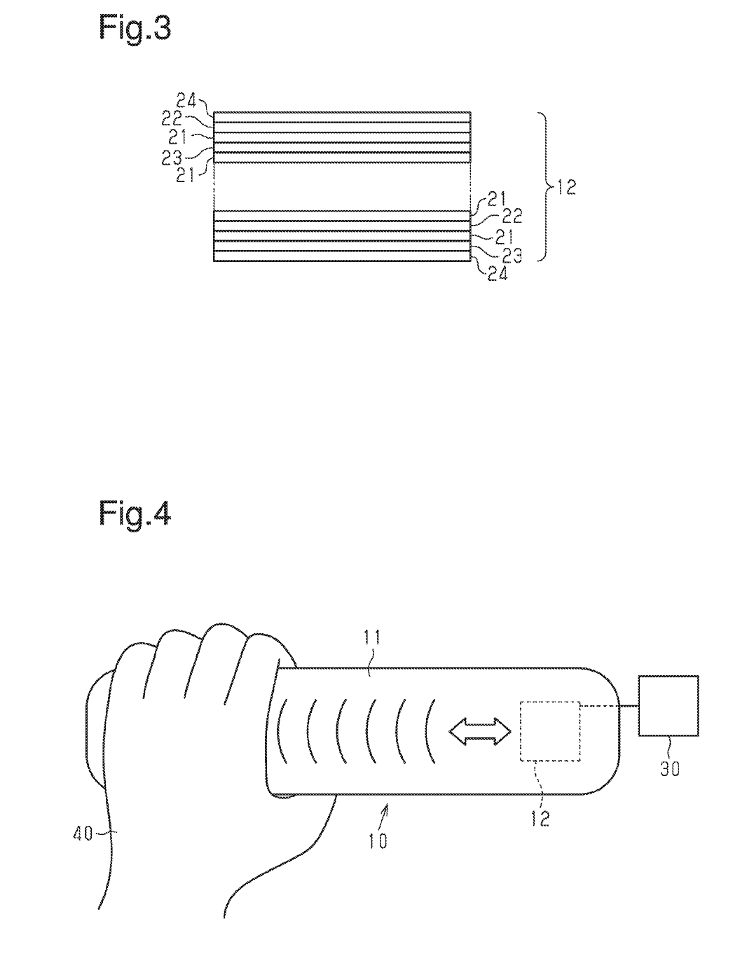

As shown in FIG. 3, the actuator 12 is a sheet-like dielectric actuator (dielectric elastomer actuator (DEA)). That is, the actuator 12 is a piezoelectric element that is made of elastomer and Includes dielectric layers 21 made of dielectric elastomer, pairs of electrode layers 22, 23, which are made of conductive elastomer, and protective layers 24 for covering the electrode layers 22, 23. Each pair of the electrode layers 22, 23 sandwiches a respective dielectric layer 21 from the opposite sides in the thickness direction.

The dielectric layers 21 and the protective layers 24 are formed by a dielectric elastomer containing a crosslinked polyrotaxane. Specifically, the dielectric elastomer includes polyethylene glycol as a linear molecule, cyclodextrin as a cyclic molecule, and adamantanamine as an end-capping group.

Additionally, the electrode layers 22 and 23 are each formed by a conductive elastomer containing an insulating polymer and a conductive filler. Silicone elastomer is used as the insulating polymer. KETJENBLACK™ is used as the conductive filler.

The thicknesses of the dielectric layers 21 and the electrode layers 22 and 23 are all in a range of tens to hundreds of micrometers.

The actuator 12 has a structure in which multiple dielectric layers 21 are laminated. The number of the dielectric layers 21 is, for example, 100.

The actuator 12 is accommodated in the covering 11 such that the lamination direction coincides with the longitudinal direction of the covering 11 (see FIGS. 1 and 2). Specifically, the actuator 12 is located in the vicinity of one end in the longitudinal direction of the covering 11.

As shown in FIGS. 1 and 2, the controller 30, which controls the vibration mode of the actuator 12, is electrically connected to the actuator 12. That is, each positive electrode layer 22 of the actuator 12 is connected to the positive terminal of a power source, which forms the controller 30, via a lead wire (not shown). Also, each negative electrode layer 23 of the actuator 12 is connected to a ground terminal of the power source via a lead wire (not shown). The controller 30 of the present embodiment is arranged outside the main body 10.

The controller 30 controls the manner in which the power source applies a direct-current voltage of 800 to 1500 V across each pair of the electrode layers 22 and 23 of the actuator 12.

In the actuator 12, when the controller 30 applies a voltage of 1200 V at a frequency of 10 Hz, for example, the amount of displacement by vibration in the lamination. direction of the actuator 12 is about 0.04 mm, and the amount of displacement by vibration in the direction orthogonal to the lamination direction is about 0.02 mm. Also, when the controller 30 applies a voltage of 1200 V at a frequency of 1 Hz, the amount of displacement by vibration in the lamination direction of the actuator 12 is about 0.08 mm, and the amount of displacement by vibration in the direction orthogonal to the lamination direction is about 0.04 mm.

An operation of the above-described embodiment will now be described.

As shown in FIG. 4, vibration generated by the actuator 12 is transmitted to the covering 11 via a large number of the transmission particles 13 filling the covering 11. Therefore, even in an area of the outer surface of the covering 11 that is distant from the actuator 12, vibration can be transmitted to tactile receptors of a hand 40 of the user that touches the outer surface of the covering 11.

Further, when the user grips the covering 11 with the hand 40, the covering 11 deformed in accordance with the shape of the hand 40, and the transmission particles 13 move within the covering 11, following the deformation of the covering 11. Thus, the vibration can be transmitted to the hand 40 of the user while the covering 11 is deformed. Moreover, the outer surface of the covering 11 touches a wide area of the hand 40 of the user at this time. Therefore, even if the vibration transmitted to the covering 11 is weak, the vibration is readily transmitted to the hand 40 of the user.

The haptic device according to the above-described embodiment has the following advantages.

(1) The main body 10 of the haptic device includes the flexible covering 11, the actuator 12, which is arranged in the covering 11 and generates vibration, and a large number of the transmission particles 13 filling the covering 11.

With this configuration, even in an area of the outer surface of the covering 11 that is distant from the actuator 12, vibration can be transmitted to tactile receptors of the hand 40 of the user that touches the outer surface of the covering 11. Thus, vibration can be transmitted to tactile receptors of the user even in a part that has a small surface area of the outer surface of the covering 11 and in which it is difficult to incorporate the actuator 12. Therefore, it is possible to transmit vibration to the flexible covering 11 in a favorable manner.

(2) The transmission particles 13 are made of foamed plastic.

With this configuration, since the transmission particles 13 are lightweight, the weight of the main body 10 is reduced. In addition, vibration generated by the actuator 12 is more readily transmitted to the covering 11 via the transmission particles 13. This allows for reduction in the size of the actuator 12 and thus in the size of the main body 10.

(3) The actuator 12 is a dielectric actuator having the dielectric layers 21, which are made of a dielectric elastomer, and pairs of the electrode layers 22, 23, which are made of a conductive elastomer and each sandwich a dielectric layer 21.

If an actuator has a mechanical driving port on such as an electric motor, transmission particles 13 may penetrate the driving portion. Therefore, using this configuration, it is necessary to take measures such as providing a sealing structure to prevent, the penetration of the transmission particles 13.

In this regard, with the above-described configuration, the actuator 12 has the laminated structure of the dielectric layers 21 and the electrode layers 22 and 23, and does not have a mechanical driving portion such as a motor. This eliminates the necessity for a sealing structure and thus avoids complication of the structure of the haptic device.

(4) Being a dielectric actuator, the actuator 12 generates no driving noise and thus achieves an excellent quietness. Also, the actuator 12 has no problem of heat generation.

### Modifications

The above-described embodiment may be modified as follows.

It is possible to accommodate the actuator 12 such that the lamination direction of the actuator 12 coincides with the radial direction of the covering 11 (the direction orthogonal to the sheet of FIG. 1). Even in this case, the actuator 12 vibrates in the longitudinal direction of the covering 11, which is a direction orthogonal to the lamination direction, so that the vibration is transmitted to the covering 11 via the transmission particles 13.

In the above described embodiment, the actuator 12 is located in a section in the covering 11 that is in the vicinity of one end in the longitudinal direction of the covering 11. Instead, the actuator 12 can be accommodated in the covering 11 so as to be located in the middle portion in the longitudinal direction of the covering 11. Further, the shape of the covering 11 can be changed to any shape.

The dielectric elastomer forming the dielectric layers 21 is not limited to polyrotaxane, but may be other dielectric elastomer such as silicone elastomer, acrylic elastomer, and urethane elastomer.

The insulating polymer of the conductive elastomer forming the electrode layers 22 and 23 is not limited to silicone elastomer, but may be other insulating polymer such as polyrotaxane, acrylic elastomer, and urethane elastomer. Further, one of these types of insulating polymer may be used alone, or two or more of these may be used in combination.

The conductive filler of the conductive elastomer forming the electrode layers 22 and 23 is not limited to KETJENBLACK™, but may be other types of carbon black or particles of metal such as copper and silver. Further, one of these types of conductive filler may be used alone, or two or more of these may be used in combination.

The actuator is not limited to a sheet-like dielectric actuator. For example, an actuator may have a tubular shape formed by rolling a sheet-like dielectric actuator. In this case, the actuator generates vibration by expanding and contracting in its axial direction.

The actuator is not limited to a dielectric actuator. For example, other electroactive polymer actuators (EPA) such as an ionic polymer meal composite (IPMC) can also be employed.

The actuator may be any device that generates vibration, and it can also be constituted by an actuator that moves rectilinearly, such as a voice coil motor.

The transmission particles can also be formed by foamed plastic other than foamed polystyrene, such as foamed polypropylene or foamed polyethylene. Also, the transmission particles are not limited to foamed plastic, but can be formed by other materials such as a hard plastic as long as vibration of the actuator can be transmitted to the covering.

The covering may be made of any material that confines the transmission particles and has plasticity, and can be formed by rubber other than silicone rubber, elastomer, foamed plastic such as polyurethane, or cloth.

If the haptic device according to the above description is employed in a sleeping pillow or the headrest of a car seat, relaxing vibration can be transmitted to the user. Moreover, if the haptic device according to the above description is employed in a communication robot such as a doll or a stuffed animal, the heartbeat of the doll or the stuffed animal can be simulated.

1. A haptic device, comprising:
a flexible covering;
an actuator provided in the covering and configured to generate vibration; and
transmission particles filling the covering.

2. The haptic device according to claim 1, wherein the transmission particles comprise foamed plastic.

3. The haptic device according to claim 1, wherein the actuator is a dielectric actuator including
a dielectric layer made of a dielectric elastomer, and
a pair of electrode layers sandwiching the dielectric layer.
